(19) United States
(12) Patent Application Publication
(10) Pub. No.: US 2008/0075327 A1
(43) Pub. Date: Mar. 27, 2008

(54) METHOD AND SYSTEM FOR OBJECT CHARACTERIZATION BASED ON IMAGE VOLUMETRIC DETERMINATION

(75) Inventors: Zygmunt Zubkow, Palm Harbor, FL (US); Jeffrey Young, Indian Shores, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/534,113

(22) Filed: Sep. 21, 2006

(51) Int. Cl. G06K 9/00

(52) U.S. Cl. 382/107; 382/154

(57) ABSTRACT

A method and system for object characterization based on image volumetric determination are provided. The method comprises capturing frames of image data for a moving object in an area from at least two different angles. The later occurring frames of image data are subtracted from previous occurring frames of image data for each of the different angles to obtain object movement information. The object movement information is correlated from the different angles over the area, and a volume of the object is determined from the object movement information.

### BACKGROUND

Frequent false alarms occur at secure remote locations that use motion sensors due to wildlife movement past the sensors. Each time an animal moves past a motion sensor or detector, an alarm is triggered that requires a response, resulting in frequent false alarms. This can interfere with the ability of security personnel to investigate real alarms when they occur.

Typically, these sites are monitored by video cameras once motion detectors are triggered. However, by this time a moving object can be missed, plus it requires human intervention to make the determination as to the object that caused the motion sensor to activate. An additional problem is motion detectors triggered by motion of tree branches due to wind. This type of motion constantly triggers motion detectors requiring constant monitoring with video cameras.

### SUMMARY

The present invention is related to a method and system for object characterization based on image volumetric determination. The method comprises capturing frames of image data for a moving object in an area from at least two different angles. The later occurring frames of image data are subtracted from previous occurring frames of image data for each of the different angles to obtain object movement information. The object movement information is correlated from the different angles over the area, and a volume of the object is determined from the object movement information.

### BRIEF DESCRIPTION OF THE DRAWINGS

Features of the present invention will become apparent to those skilled in the art from the following description with reference to the drawings. Understanding that the drawings depict only typical embodiments of the invention and are not therefore to be considered limiting in scope, the invention will be described with additional specificity and detail through the use of the accompanying drawings, in which:

FIGS. 1A and 1B are schematic diagrams depicting a system and method for object characterization according to one embodiment of the invention; and

FIG. 2 is a processing flow diagram indicating further details for the method of object characterization used in the system of FIGS. 1A and 1B.

### DETAILED DESCRIPTION

In the following detailed description, embodiments are described in sufficient detail to enable those skilled in the art to practice the invention. It is to be understood that other embodiments may be utilized without departing from the scope of the present invention. The following detailed description is, therefore, not to be taken in a limiting sense.

The present invention relates to a method and system for object characterization based on image volumetric determination. The method and system address the problem of frequent false alarms that occur at remote secure locations because of animals in the wild or wind movement on landscaping that triggers an alarm. The method and system can be used to determine the volume of a moving object such as an animal, plant, or human so that false alarms can be minimized.

The present method generally comprises capturing frames of image data for a moving object in an area from at least two different angles. The later occurring frames of image data are subtracted from previous occurring frames of image data for each of the different angles to obtain object movement information. The object movement information is correlated from the different angles over the area, and a volume of the object is determined from the object movement information. Objects out of bounds of volumes within human range can be rejected before an alarm is triggered.

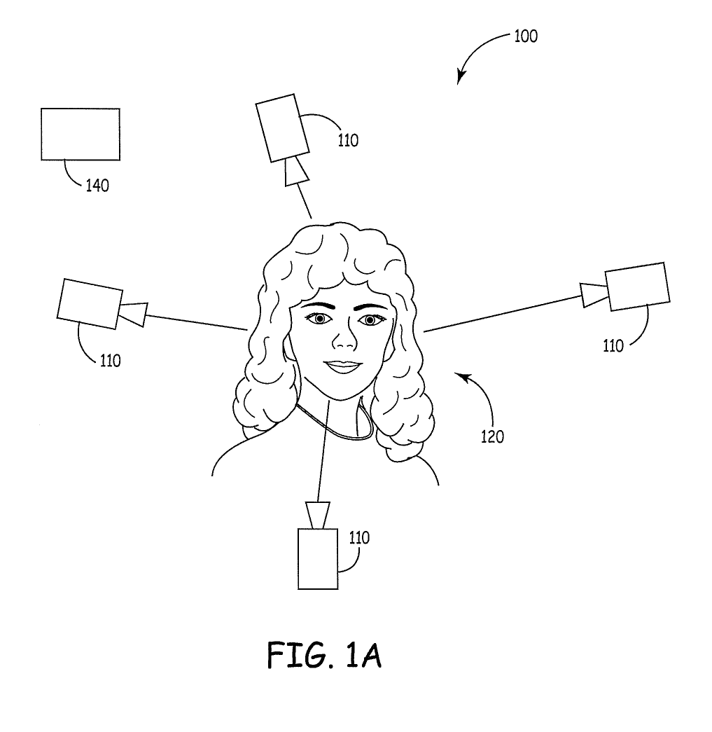

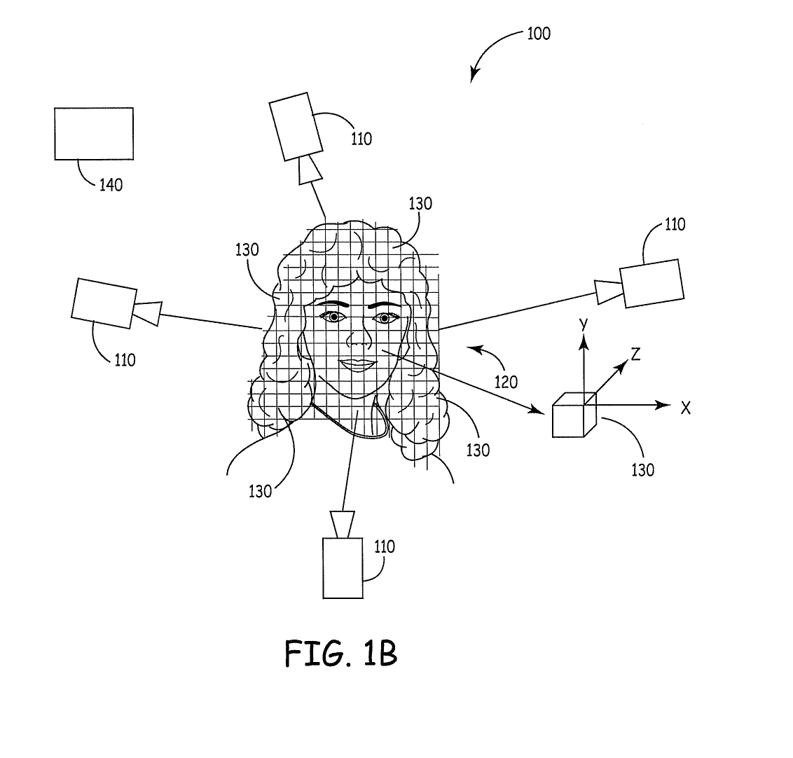

FIGS. 1A and 1B are schematic diagrams depicting a system 100 for object characterization according to one embodiment of the invention. A means for capturing frames of image data for a moving object is provided in an area such that the frames of image data are captured from at least two different angles. For example, a plurality of video cameras 110 can be mounted in an area of interest so that image information can be captured at different angles. Although four video cameras are shown, it should be understood that at least two video cameras positioned at orthogonal locations with respect to each other can be used. Other configurations with a different number of video cameras can also be used as desired.

The multiple camera angles provided by video cameras 110 are used to triangulate on and capture an image of an object 120. Video subtraction and volumetric approximations from correlated data are then used to determine if the object is potentially human. For example, each video camera 110 records frames of image data that are subtracted from previous frames so that only moving objects are highlighted. The moving information is then correlated between the different video cameras over the same area. As shown in FIG. 1B, the image of the object 120 is broken into three-dimensional blocks 130 and the dimension of each block is calculated. A volumetric determination of the object can then be calculated by a summation of all block dimensions.

A computing device 140, such as a personal computer or digital signal processors, can be in operative communication with video cameras 110 so that the image data can be processed and analyzed as described above. A means for determining distance to the moving object from the video cameras can also be used, such as one or more range finders. The range finders can be employed in conjunction with video cameras 110, and can be used to aide in sizing the object in the video cameras.

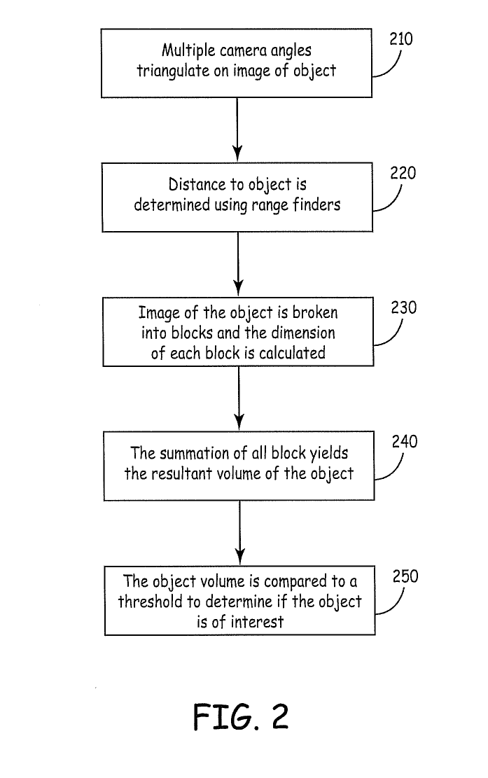

FIG. 2 is a processing flow diagram indicating further details for the method of object characterization used in the system of FIGS. 1A and 1B. Initially, multiple camera angles triangulate on an image of an object that is moving (block 210). Only moving object images appear due to frame grabbing and subtraction techniques that are employed. The distance to the imaged object is determined using one or more range finders (block 220). The image of the object is broken into blocks and the dimension of each block is calculated (block 230). The summation of all block dimensions yields the resultant volume of the object (block 240). The volume of the moving object is compared to a threshold to determine if the object is of interest (block 250). The threshold is determined by establishing the expected volume of a human body. If the object is out of bounds for volumes within human range, it can be rejected as a false alarm.

Instructions for carrying out the various process tasks, calculations, control functions, and the generation of signals and other data used in the operation of the system and method described herein can be implemented in software, firmware, or other computer readable instructions. These instructions are typically stored on any appropriate computer readable media used for storage of computer readable instructions or data structures. Such computer readable media can be any available media that can be accessed by a general purpose or special purpose computer or processor, or any programmable logic device.

Suitable computer readable media may comprise, for example, non-volatile memory devices including semiconductor memory devices such as EPROM, EEPROM, or flash memory devices; magnetic disks such as internal hard disks or removable disks; magneto-optical disks; CDs, DVDs, or other optical storage disks; nonvolatile ROM, RAM, and other like media. Any of the foregoing may be supplemented by, or incorporated in, specially-designed application-specific integrated circuits (ASICs). When information is transferred or provided over a network or another communications connection (either hardwired, wireless, or a combination of hardwired or wireless) to a computer, the computer properly views the connection as a computer readable medium. Thus, any such connection is properly termed a computer readable medium. Combinations of the above are also included within the scope of computer readable media.

The method of the invention can be implemented in computer readable instructions, such as program modules or applications, which are executed by a data processor. Generally, program modules or applications include routines, programs, objects, data components, data structures, algorithms, etc. that perform particular tasks or implement particular abstract data types. These represent examples of program code means for executing steps of the method disclosed herein. The particular sequence of such executable instructions or associated data structures represents examples of corresponding acts for implementing the functions described in such steps.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A method for object characterization based on image volumetric determination, the method comprising:
capturing frames of image data for a moving object in an area from at least two different angles;
subtracting later occurring frames of image data from previous occurring frames of image data for each of the different angles to obtain object movement information;
correlating the object movement information from the different angles over the area; and
determining a volume of the object from the object movement information.

2. The method of claim 1, wherein the image data is captured with at least two video cameras at orthogonal locations with respect to each other.

3. The method of claim 1, wherein the image data is captured using multiple camera angles to triangulate on an image of the moving object.

4. The method of claim 2, further comprising determining a distance to the moving object from the video cameras by using one or more range finders.

5. The method of claim 1, wherein the volume is determined by:
breaking the image data of the object into a plurality of blocks;
calculating the dimension of each of the blocks; and
summing together the dimensions of all the blocks.

6. The method of claim 1, further comprising comparing the volume of the object to a threshold to determine if the object is of interest.

7. The method of claim 6, wherein the threshold is determined by establishing the expected volume of a human body.

8. A computer readable medium having instructions stored thereon for a method of object characterization based on image volumetric determination, the method comprising:
capturing frames of image data for a moving object in an area from at least two different angles;
subtracting later occurring frames of image data from previous occurring frames of image data for each of the different angles to obtain object movement information;
correlating the object movement information from the different angles over the area; and
determining a volume of the object from the object movement information.

9. The computer readable medium of claim 8, wherein the volume is determined by:
breaking the image data of the object into a plurality of blocks;
calculating the dimension of each of the blocks; and
summing together the dimensions of all the blocks.

10. The computer readable medium of claim 8, wherein the method further comprises comparing the volume of the object to a threshold to determine if the object is of interest.

11. The computer readable medium of claim 10, wherein the threshold is determined by establishing the expected volume of a human body.

12. A system for object characterization based on image volumetric determination, the system comprising:
means for capturing frames of image data for a moving object in an area from at least two different angles; and
a computing device in communication with the means for capturing frames of image data, the computing device having executable instructions stored therein comprising:
program code means for subtracting later occurring frames of image data from previous occurring frames of image data for each of the different angles to obtain object movement information;
program code means for correlating the object movement information from the different angles over the area; and
program code means for determining a volume of the object from the object movement information.

13. The system of claim 12, wherein the means for capturing frames of image data comprises at least two video cameras at orthogonal locations with respect to each other.

14. The system of claim 13, further comprising means for determining distance to the moving object from the video cameras.

15. The system of claim 14, wherein the means for determining distance comprises one or more range finders.

16. The system of claim 12, wherein the program code means for determining a volume of the object further comprises:
program code means for breaking the image data of the object into a plurality of blocks;
program code means for calculating the dimension of each of the blocks; and
program code means for summing together the dimensions of all the blocks.

17. The system of claim 12, further comprising program code means for comparing the volume of the object to a threshold to determine if the object is of interest.

18. The system of claim 17, wherein the threshold is the expected volume of a human body.
